(19) United States
(12) Patent Application Publication
(10) Pub. No.: US 2005/0124318 A1
(43) Pub. Date: Jun. 9, 2005

(54) Telecommunications security system with emergency call after designated period of time

(76) Inventor: Bong Jin Jeon, Glendale, AZ (US)

Correspondence Address: ETHERTON LAW GROUP, LLC, 5555 E. VAN BUREN STREET, SUITE 100, PHOENIX, AZ, 85008, US

(21) Appl. No.: 10/731,318

(22) Filed: Dec. 8, 2003

(51) Int. Cl. H04M 3/16

(52) U.S. Cl. 455/411

(57) ABSTRACT

A transceiver security system which provides security to a transceiver user by transmitting information, including an encoded period of time and a request for help, to a computer server. After the period of time expires, an alert call is made from the computer server to the transceiver user. Depending on the response from the transceiver user, the computer server may contact an emergency service provider.

### FIELD OF INVENTION

This invention relates generally to telecommunications systems. This invention relates particularly to a mobile phone system that enables a user to call for help, or abort a call for help, after a designated period of time.

### BACKGROUND

A person who anticipates that a crime is about to occur will often call 911 for help. Under the existing 911 system, if the call ends up being a false alarm, emergency service resources will be wasted. Such a process is inadequate because the person must choose between security and wasting the efforts of emergency service providers. For example, a woman is walking in a dark parking lot. As the potential victim senses danger, she calls 911 on her cell phone and police are dispatched. If there is an actual threat to her safety, the police may arrive in time to preserve her security. However, if there is no threat to her safety, police resources will be wasted by driving, investigating, and possibly drafting a report for an event that never occurred. It is desirable to have a security system which would enable a potential victim to prepare without hesitation for a security threat when she senses danger, but yet avoid false alarms.

In another example, a wife in a domestic dispute who anticipates being physically attacked by her husband may unnecessarily waste the efforts of a police officer who is called out to address what may remain a shouting match. However, if she is about to be attacked, the arrival of a police officer could protect her from serious injury or death. Furthermore, calling the police may ultimately aggravate the husband from an otherwise non-violent condition to a violent condition. As a result, a security system capable of contacting the police without the husband noticing, which protects the wife and provides her with the opportunity to cancel a call for help and prevent a false alarm, would be highly desirable.

Telephone panic button systems are known. These systems enable a caller to push a dedicated key or series of keys that calls the police. At least one of the systems applied to mobile phones, U.S. Pat. No. 5,742,666 issued to Alpert, provides an abort button for the panic call. However, the prior art fails to disclose a system in which the user can define a period of delay before emergency services are called. Furthermore, these systems allow any person—even the perpetrator—to abort the call. They do not provide for cancellation by only the victim.

Therefore, a primary object of the present invention is to provide an improved security system that enables the potential victim to call for help, but to abort the call if it is a false alarm. Another object of this invention is to provide the potential victim with the security of knowing that help is on the way, unless the potential victim cancels the request for help. A further object is to enable a person to quickly and, if desired, discreetly contact emergency service providers. Another object of the present invention is to provide a system capable of reducing the number of false alarms to emergency service providers. Another object of the present invention is to provide a system capable of communicating the circumstances of a potential crime, such as the locations and identities of the potential victim and perpetrators involved. Another object of the present invention is to provide a system that is efficient and requires minimal cost, time, and effort. Other objects and features of this invention will become apparent with reference to the following descriptions.

### SUMMARY OF THE INVENTION

The present invention is a security system which provides security to a cell phone user by transmitting information, including an encoded period of time and a request for help, to a computer. After the period of time expires, the computer calls the cell phone user back. The cell phone user may abort the request for help by entering a personal identifier. If the cell phone user does not enter the personal identifier signifying that he or she is no longer in danger, the computer contacts appropriate authorities such as the police, fire department, or paramedics. Other information may be transmitted, such as the locations and identities of the victim and perpetrators involved, using voice, text, visual images, geographic coordinates or other formats.

### BRIEF DESCRIPTION OF THE DRAWINGS

FIG. 1 is a flow diagram illustrating an overview of the present invention.

FIG. 2 is a flow diagram illustrating the steps implemented by components of the preferred embodiment of the present invention.

FIG. 3 is a flow diagram illustrating the steps implemented by components of an alternative embodiment of the present invention.

FIG. 4 is a flow diagram illustrating the steps implemented by components of a second alternative embodiment of the present invention.

FIG. 5 illustrates the information gathered in the application for the service of system described herein.

FIG. 6 is a flow diagram illustrating the detailed steps of the present invention.

### DETAILED DESCRIPTION OF THE INVENTION

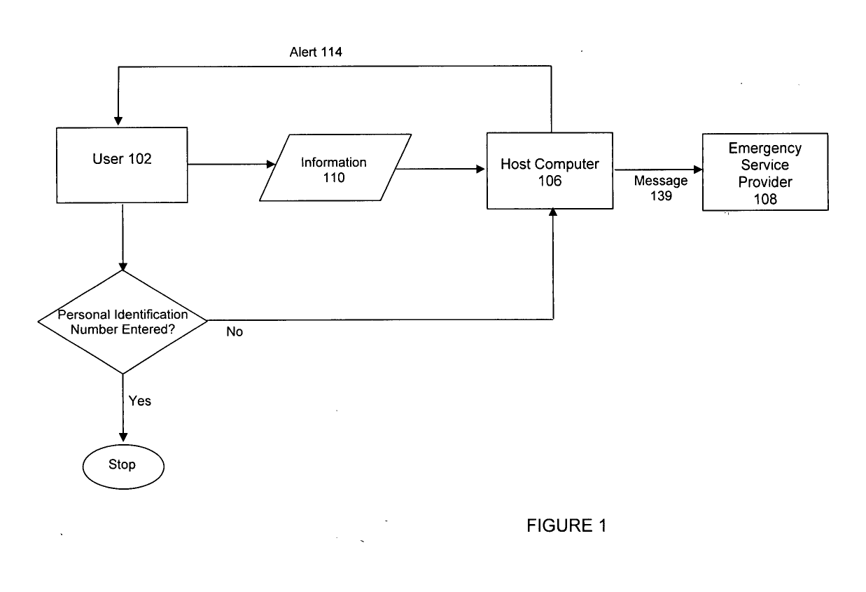

Referring to FIG. 1, the system comprises a method of providing security to a person who has a mobile phone or other means for transmitting and receiving. The mobile phone user 102 transmits information 110 to a host computer 106. The transmitted information 110 includes at least a period of time 112 that the user 102 believes will be sufficient to determine whether a threat is real. The host computer 106 receives the information and, after the period of time 112 elapses, the host computer calls the user back with an alert 114. Unless the user 102 enters a personal identifier such as a personal identification number (PIN), the host computer will contact an emergency service provider 108. For example, if a user who senses danger believes it will take 40 seconds to safely walk to his car, the user 102 may transmit a code that indicates to the host computer to wait 40 seconds before calling the user back for confirmation he is safe. If the user enters his PIN upon receiving the call back, no call is made to emergency service providers 108. If the user fails to enter his PIN, however, the host computer 106 contacts emergency service providers 108 with a message 139 that the user needs help.

The user 102 may transmit additional information 110 to the host computer 106. This additional information may include for example a text message 145, voice data 140, a visual image 141, location data 142, the identity 143 of user 102, identities of the perpetrators 144, or other data. Other data formats may be used, also. Similarly, the host computer 106 may transmit additional information in the message 139 to the emergency service provider 108. Again, this additional information may include for example a text message 145, voice data 140, a visual image 141, location data 142, the identity 143 of user 102, or identities of the perpetrators 144 or other data. Other data formats may be used, also. This additional information may be provided by the user or obtained from other sources. Location data 142 for land telephone lines may be obtained by host computer 106 utilizing Automatic Location Identification (ALI), as is known in the art. Location data 142 for cell phones may be obtained by host computer 106 by utilizing Global Positioning System (GPS), also known in the art. Automatic Number Identification (ANI) is an enhanced 911 service capability that may also be utilized by host computer 106 to automatically display the seven digit number used to place a 911 call. Alternatively, user 102 may also enter other forms of information 110, such as requesting the dispatch of help to locations other than from where the initial call is placed.

The device used by the caller to make the initial call is preferably a device that transmits and receives data, in other words, a transceiver. The transceiver 104 is preferably a cell phone but under appropriate circumstances other means for transmitting and receiving, such as pagers, computers, PDA's, other types of mobile phones, etc., may suffice. The transceiver and host computer 106 are capable of transmitting and receiving transmissions from each other. Transceiver 104 and host computer 106 may consist of separate transmitters and receivers, rather than combined into transceiving. For example, the user 102 may be provided with a security transmitter for one-time use. This disposable transmitter transmits to the host computer 106, as explained above, but the host computer calls back to the user's cell phone, a separate device form the transmitter. In such case, the data transmitted by the disposable transmitter may additionally include the user's call back number.

The host computer is preferably a dedicated server, but may also be a portion of the mainframe computer or servers for existing telephone or emergency services. For example, the service of the present invention may be incorporated into the local telephone service provider or local emergency service provider networks. The host computer may be managed by a local telephone service provider, a home security company, local emergency service provider, a municipality or other entity.

Emergency service provider 108 is preferably a law enforcement entity such as the police department. Under appropriate circumstances, considering issues such as nature of the emergency, culture, cost, etc., other emergency service providers, such as firefighters, paramedics, other medical professionals, military, other law enforcement entities, mechanics, plumbers, veterinarians, etc., may be contacted. Further, the host computer may contact a family member, employer, or other emergency contact that is not necessarily capable of rendering emergency aid. Those contacted by the host computer are referred to collectively herein as emergency service providers.

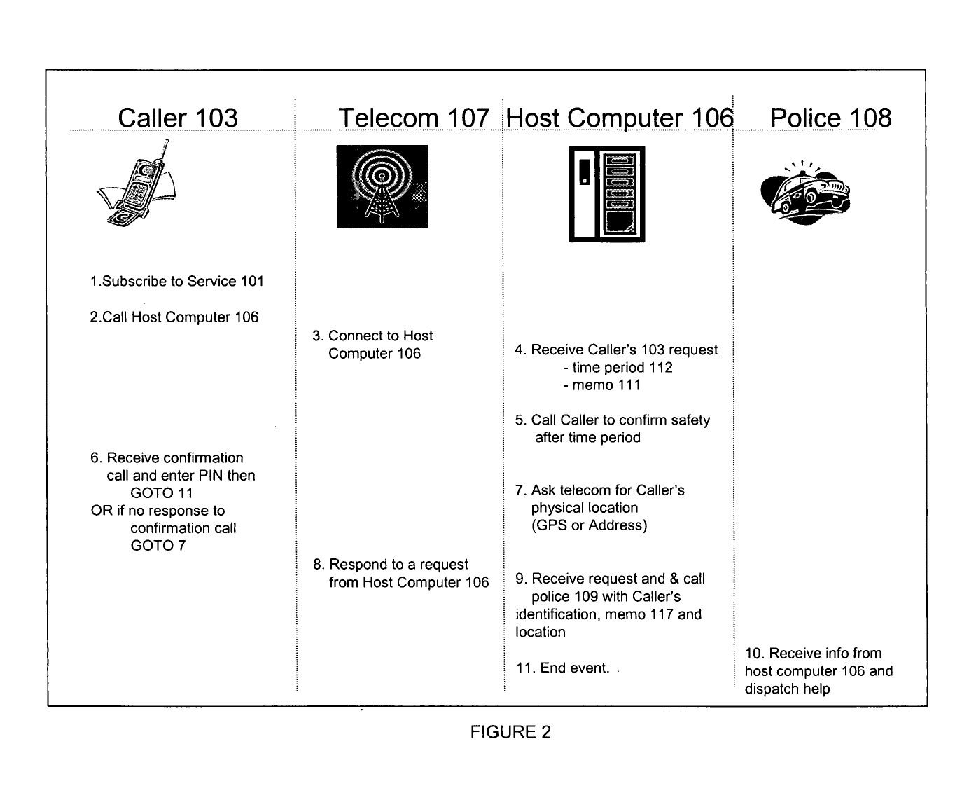

FIG. 2 illustrates the method implemented by the components of the system, in which he steps are numbered in the preferred order of execution. In this more detailed embodiment, the method provides a physical location of the user. A caller 103 subscribes to the service 101 described herein. When a threat is sensed, the caller 103 places a call to the host computer 106 which is transmitted through a telecommunications system 107. The host computer receives the caller's request, which includes at least a time period 112 for call back and, if desired, a memo 111 with additional information. After the period of time 112 has elapsed, the host computer calls the caller 103 to confirm her safety. The host computer 106 receives confirmation by way of receipt of a PIN or other personal identifier entered by the caller 103. Upon receipt of confirmation the caller is safe, the security event ends, illustrated by jumping to Step 11. However, if no confirmation is received, Step 7 is executed as the host computer queries the telecom system 107 for the caller's physical location. The telecom system 107 responds to the host computer 106 with the location. Once the location is received, the host computer contacts the police or other emergency service provider 108 with the caller's identity, memo (if provided) 117 and location. The memo may include for example a text message 145, voice data 140, a visual image 141, identities of the perpetrators 144, or other data. Other data formats may be used. Upon receipt of the information by the police in Step 10, help is dispatched. Upon dispatch, the security event ends at Step 11.

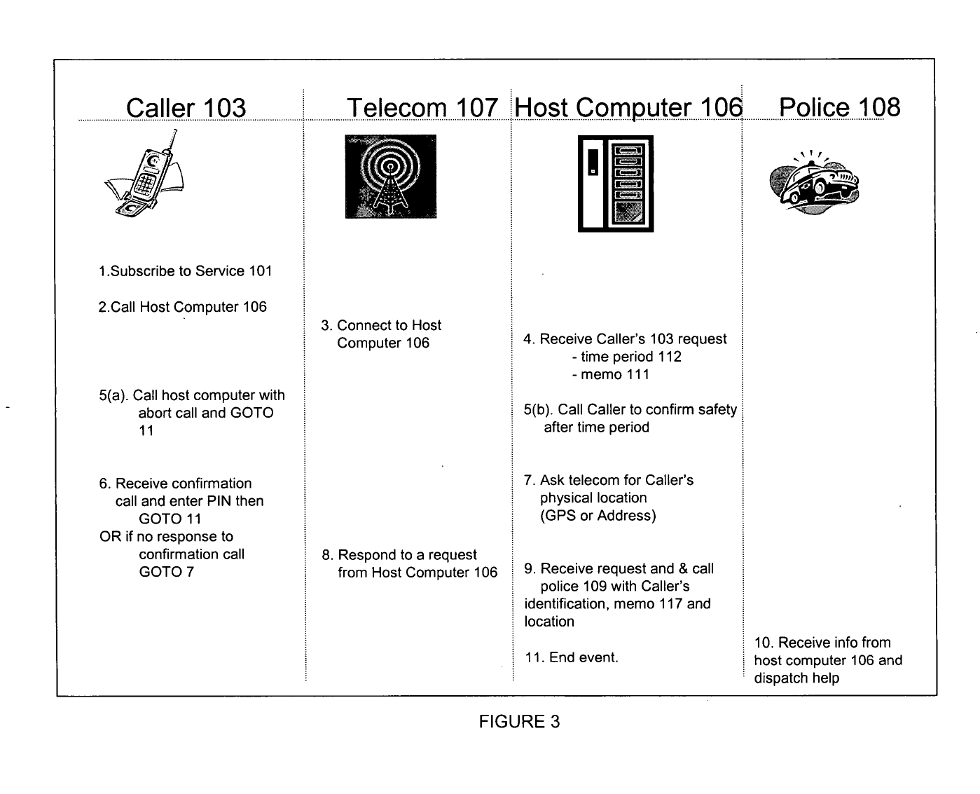

In an alternate embodiment, instead of waiting for the alert 114 call to enter the PIN in Step 5 and thereby abort the call for help, the caller 103 can preemptively abort the emergency call by making another call to the host computer. See FIG. 3. Step 5(a) shows that the caller 103 can call the host computer 106 before the time period 112 expires and abort the emergency call. If the caller 103 does not execute Step 5(a), the process continues as in the preferred embodiment from Step 5(b) through completion.

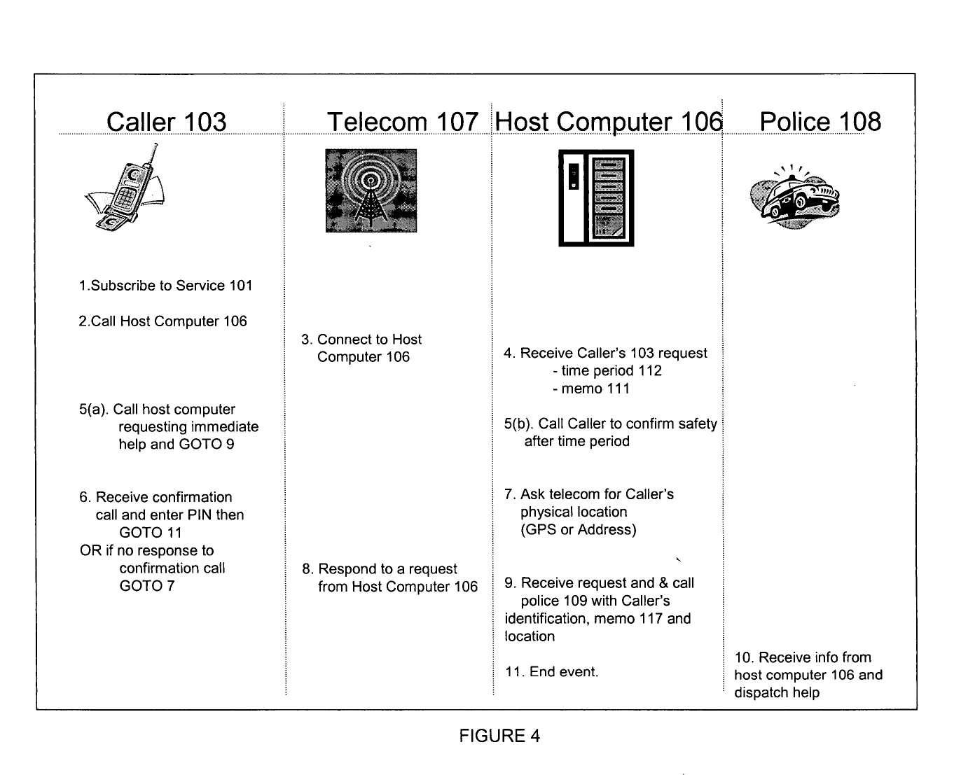

In a second alternative embodiment, instead of waiting for the alert 114 call in Step 5, the caller 103 can request immediate help by making another call to the host computer. See FIG. 4. Step 5(a) shows that the caller 103 can call the host computer 106 before the time period 112 expires and request immediate help. If the caller 103 does not execute Step 5(a), the process continues as in the preferred embodiment from Step 5(b) through completion.

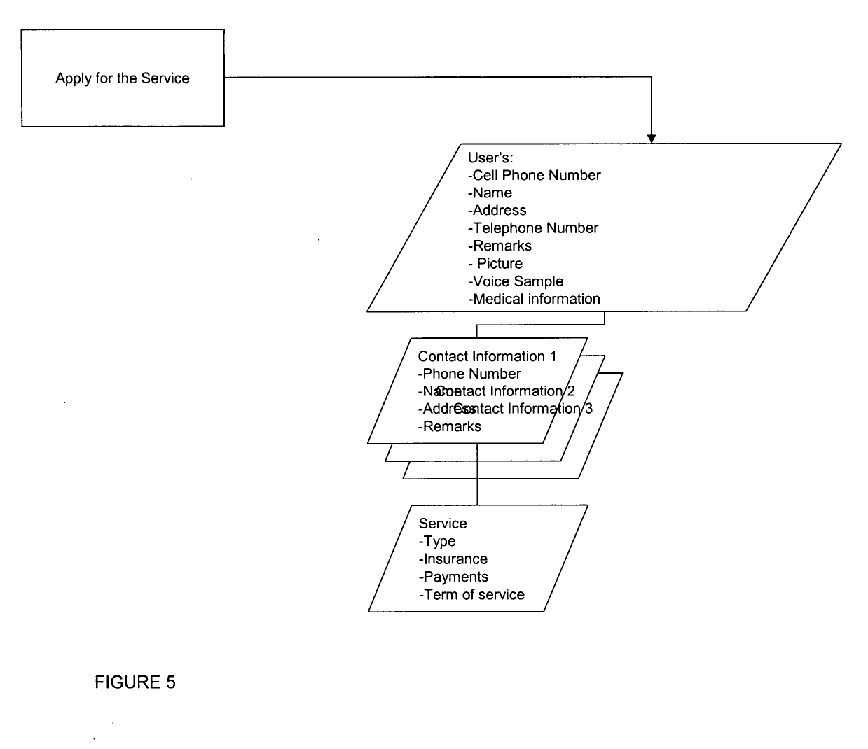

As shown in FIG. 5, prior to having the ability to transmit to host computer 106, a user 102 preferably applies for this service, preferably providing his or her name, cell phone number, address, home telephone number, and any additional remarks and related information. Additionally, user 102 may provide a picture of himself, a voice sample, or medical information, such as blood type or allergies to medicines that might be used in an emergency. User 102 may also provide contact information for at least one other emergency contact, including that person's name, cell phone number, address, home telephone number, and any additional remarks and related information. Details of service would also be determined, such as type, new PIN, insurance, payments, number of alert calls, preferred methods of canceling requests for help, length of service term, and term of validity.

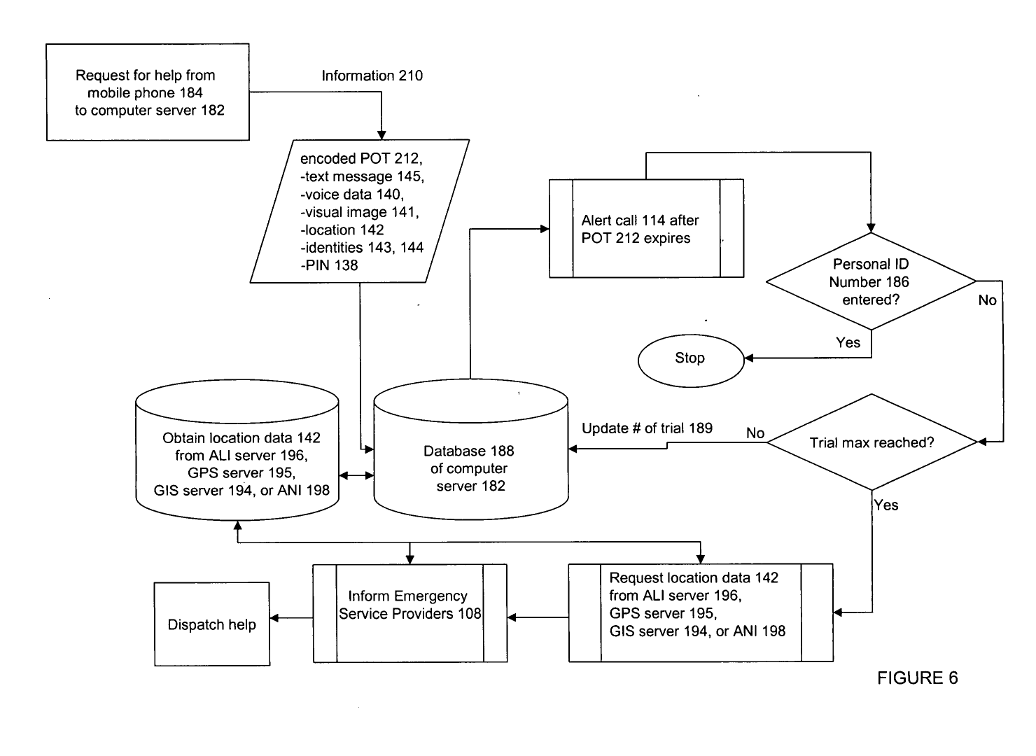

The preferred embodiment of the invention enables for a cell phone user to make a request 180 for help to an autonomous computer server 182 programmed specifically for this use. See FIG. 6. The request includes an encoded period of time 212 (abbreviated in FIG. 6 as “POT”), which could be entered into a cell phone 184, for example, by typing “*410”. The “*4” would represent a speed dial number preprogrammed into cell phone 184, which calls server 182. The “10” represents a period of time 212, such as “10” seconds, the desired period of time before call-back. Other codes could be initially entered, such as “*4*210”, whereby “*4” is the number speed-dialed, “*2” is a request for an ambulance, and “10” represents the period of time 212. The request for help may include a text message 145, voice data 140, a visual image 141, location data 142, the identity 143 of user 102, or identities of the perpetrators 144 or other data. Optionally, the request for help may require entry of a PIN 186, in order to make an initial request for help. The information 210 is stored in a main database 188, which is connected to server 182.

Server 182 would then call and provide an alert 114 to cell phone 184 that the period of time 212 has expired. If cell phone 184 answers the alert call and the PIN 186 is entered, no request for help from an emergency service provider 108 would be made by server 182. If the alert call is not answered or a proper PIN 186 is not entered after cell phone 184 is answered, a request for help would be transmitted from server 182 to emergency service provider 108, preferably by a facsimile 192 and a phone call 193. Alternatively, to further avoid false alarms, server 182 can be arranged to make more than one alert call trial 189 to cell phone user 102. Once the maximum number of alert call trials 189 is reached, emergency service provider 108 are then contacted. In addition, service could also be arranged such that server 182 does not make an alert call, but instead waits for a period of time 212 for a second call from the user. If server 182 receives the second call during the wait time 212, a transmission for help is then made to emergency service provider 108. If the second call does not come within the period of time 212, server 182 would not make a request for help to emergency service provider 108. Optionally, emergency service provider 108 could be required to make a confirmation call 196 back to server 182.

Server 182 would maintain a main database 188, which includes all information 210. Server 182 would also have access to data from Geographic Information Systems (GIS) servers 194, Global Positioning Systems servers 195, Automatic Number Identification servers 198, Automatic Location Identification servers 196, internet servers, telecommunications servers, and any other databases which will assist in helping police 208 in aiding user 102. Such steps could all be autonomously executed by a computer server 182 utilizing batch processes. In the event insufficient information is transmitted to the emergency service provider, the emergency service provider could also request information from these and other databases.

While there has been illustrated and described what is at present considered to be the preferred embodiment of the present invention, it will be understood by those skilled in the art that various changes and modifications may be made and equivalents may be substituted for elements thereof without departing from the true spirit and scope of the invention. Therefore, it is intended that this invention not be limited to the particular embodiment disclosed, but that the invention will include all embodiments falling within the spirit and scope of the appended claims.

1. A method for providing security to a transceiver user comprising:
a) transmitting information, including a period of time, from a transceiver to a computer; and
b) unless the computer is instructed otherwise by the transceiver user, transmitting information from the computer to an emergency service provider after the period of time has elapsed.

2. The method of claim 1 wherein an alert is transmitted from the computer to the transceiver when the period of time has elapsed.

3. The method of claim 1 wherein the transceiver user must transmit a personal identification number in order to prevent transmission between the computer and the emergency service provider.

4. The method of claim 1 wherein the transceiver user must initiate a second transmission of information to the computer in order to prevent transmission between the computer and the emergency service provider.

5. The method of claim 1 wherein the transceiver is a cell phone.

6. The method of claim 1 wherein the information further comprises text data.

7. The method of claim 1 wherein the information further comprises voice data.

8. The method of claim 1 wherein the information further comprises a visual image.

9. The method of claim 1 wherein the information further comprises the transceiver's location.

10. A method for providing security to a cell phone user comprising:
a) entering information into a cell phone by pressing a series of keys, the information comprising in encoded form,
i. at least one telephone number connecting to a computer server, and
ii. a cell phone user specified period of time;
b) transmitting the information from the cell phone to the computer server;
c) receiving a call on the cell phone from the computer server after the period of time has elapsed; and
d) unless the cell phone user answers the call and enters a predetermined personal identification number into the cell phone, transmitting a message from the computer server to an emergency service provider, wherein the message comprises at least one of the following:
i. a request for help;
ii. location data acquired by utilizing at least one of the following,
1. global positioning systems,
2. geographic information system,
3. automatic number identification system,
4. automatic location identification systems, or
5. the cell phone user;
iii. text data;
iv. voice data, or
v. a visual image, and
wherein the emergency services provider is at least one of the following,
i. law enforcement,
ii. fire department,
iii. paramedics, or
iv. military

11. An apparatus for alerting an emergency service provider of an emergency, comprising:
a) means for receiving from a transceiver information which includes a transceiver user specified period of time and a user personal identification number;
b) means for transmitting to the transceiver an alert after the period of time has elapsed; and
c) means for transmitting to the emergency service provider the information if the period of time has elapsed and the user's personal identification number has not been received.

12. The apparatus of claim 11 wherein the means for receiving is a computer.

13. The apparatus of claim 11 wherein the means for transmitting an alert and the means for transmitting the information are telecommunications devices.

14. The apparatus of claim 11 wherein the period of time is embodied in a code.

15. An apparatus for providing security to a user of a first means for transmitting, comprising:
a) first means for transmitting information which includes a user specified period of time and a user personal identification number; and
b) first means for receiving an alert after the period of time has elapsed.

16. The apparatus of claim 15 wherein the first means for transmitting and the first means of receiving are separate devices.

17. The apparatus of claim 16 wherein the first means for receiving is a cell phone.

18. The apparatus of claim 15 wherein the period of time is embodied in a code.

19. The apparatus of claim 15 further comprising:
a) second means for receiving, from the first means for transmitting, information which includes a user specified period of time and the user's personal identification number;
b) second means for transmitting, to the first means for transmitting, an alert that the period of time has elapsed; and
c) third means for transmitting, to an emergency service provider, the information if the period of time has elapsed and the user's personal identification number has not been received.
